(19) United States
(12) Patent Application Publication
(10) Pub. No.: US 2014/0218607 A1
(43) Pub. Date: Aug. 7, 2014

(54) DIVIDING HIGH RESOLUTION VIDEO FRAMES INTO MULTIPLE LOWER RESOLUTION VIDEO FRAMES TO SUPPORT IMMERSIVE PLAYBACK RESOLUTION ON A PLAYBACK DEVICE

(71) Applicant: Condition One, Inc., Mill Valley, CA (US)

(72) Inventors: Peter Wilkins, Novato, CA (US); Christopher Ryan Wheeler, San Jose, CA (US); Jay Brown, Belmont, CA (US); Barton Wells, Palo Alto, CA (US)

(21) Appl. No.: 14/150,703

(22) Filed: Jan. 8, 2014

Related U.S. Application Data
(60) Provisional application No. 61/749,945, filed on Jan. 8, 2013.
(60) Provisional application No. 61/749,953, filed on Jan. 8, 2013.

(51) Int. Cl. H04N 7/01

(52) U.S. Cl. CPC H04N 7/0117
USPC 348/441

(57) ABSTRACT

Generating a geometric playback surface with subdivisions for playing playback content. Subdividing at least one source file that includes playback content into a plurality of subdivided source files. Aggregated playback content is mapped form subdivided source files to the subdivisions of the geometric playback surface. A virtual sensor is placed on the playback surface and a portion of the mapped aggregated playback content is played based on the position of the virtual sensor on the geometric playback surface.

### CROSS-REFERENCE TO RELATED APPLICATION

This application claims priority to U.S. Provisional Ser. No. 61/749,945, filed Jan. 8, 2013, entitled “Dividing High Resolution Video Frames into Multiple Lower Resolution Video Frames to Support Immersive Playback Resolution on a Playback Device,” and U.S. Provisional Ser. No. 61/749,953, filed Jan. 8, 2013, entitled “Dividing High Resolution Video Frames from a Single Sensor into Multiple Lower Resolution Video Streams to Support Immersive Playback Resolution on a Playback Device,” all of which are incorporated herein by reference.

### BACKGROUND

Applicable devices are being used more and more for video playback. Many devices include specialty sensors (e.g., accelerometer, gyroscope, compass, etc.), but devices can be arbitrarily limited by:

1) the resolution of a single video stream that can be played back (for example, the current generation of iOS devices only supports a stream at 1920×1080 maximum resolution), while the display can handle higher resolutions, and media is becoming more common at even higher resolutions (e.g., 2K, 4K, 5K, etc.).

2) The size of a single texture that can be transferred to a general processing unit (GPU) to be mapped onto 3D geometry.

In previous implementations, a single video sample image was mapped onto a single hemispheric geometry to provide an immersive experience, however this greatly limited the resolution that could be displayed and limited the immersive experience.

Other limitations of the relevant art will become apparent to those of skill in the art upon a reading of the specification and a study of the drawings.

### SUMMARY

Various implementations include systems and methods for subdividing high resolution video to eliminate or ameliorate limitations of the prior art, providing a higher resolution and more immersive playback experience.

Various implementations also include systems and methods for generating a geometric playback surface with subdivisions for playing playback content. At least one source file that includes playback content is subdivided into a plurality of subdivided source files. Aggregated playback content is mapped form subdivided source files to the subdivisions of the geometric playback surface. A virtual sensor is placed on the playback surface and a portion of the mapped aggregated playback content is played based on the position of the virtual sensor on the geometric playback surface.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for immersive playback resolution on a playback device.

FIG. 2 is intended to illustrate a specific example of generating playback surface portions from a base geometry.

FIG. 3 is intended to illustrate a specific example of a virtual sensor centered on a playback surface geometry.

FIG. 4 depicts a diagram an example of a system for recording video content and storing the video content in subdivisions for synchronized aggregated playback.

FIG. 5 depicts a diagram an example of a system for displaying a portion of playback content revealed by a virtual sensor.

FIG. 6 depicts a flowchart of an example of a method of controlling playback flow between source file players and a renderer.

FIG. 7 depicts a flowchart of an example of a method of dividing high resolution video frames into multiple low resolution video frames to support immersive playback resolution on a playback device.

FIG. 8 is intended to illustrate a specific example of playback/rendering flow.

FIG. 9 depicts a flowchart of an example of a method of dividing high resolution video frames into multiple low resolution video frames to support immersive playback resolution on a playback device.

### DETAILED DESCRIPTION

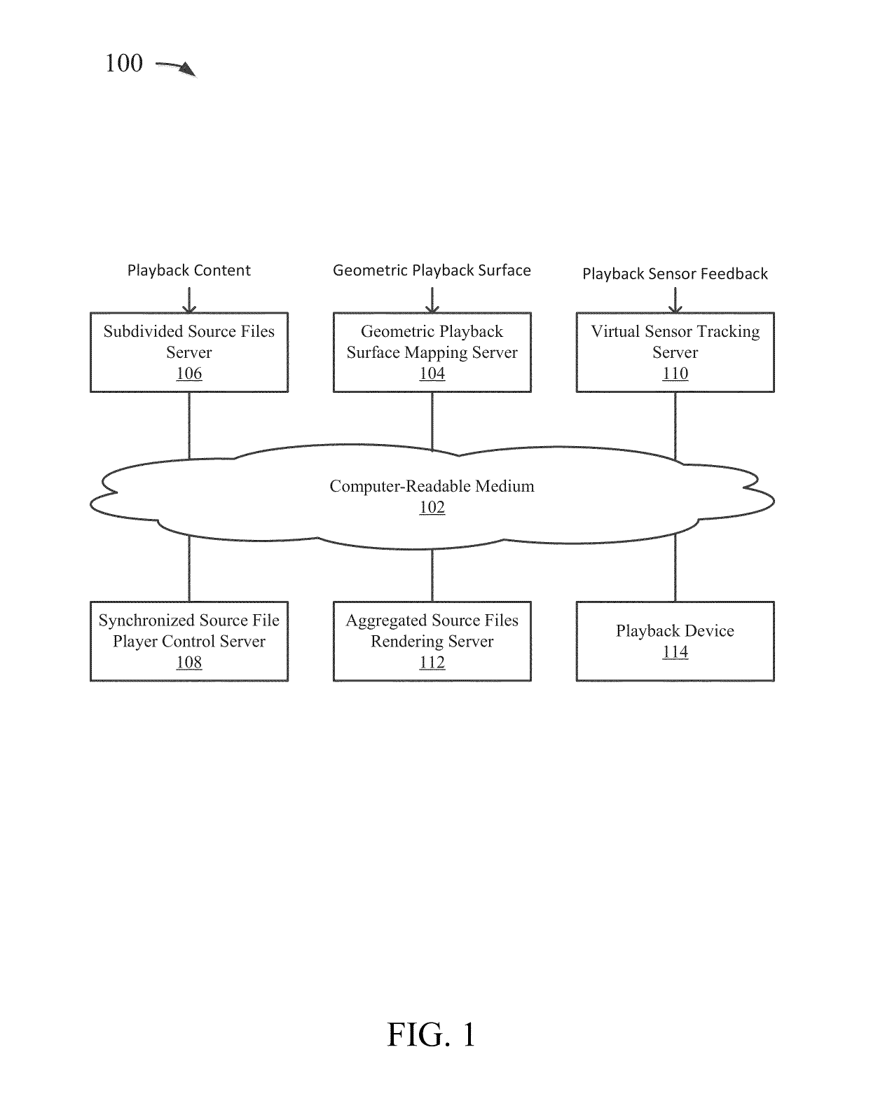

FIG. 1 depicts a diagram 100 of an example of a system for immersive playback resolution on a playback device. In the example of FIG. 1, the diagram 100 includes a computer-readable medium 102, a geometric playback surface mapping server 104 coupled to the computer-readable medium 102, a subdivided source files server 106 coupled to the computer-readable medium 102, a synchronized source file player control server 108 coupled to the computer-readable medium 102, a virtual sensor tracking server 110 coupled to the computer-readable medium 102, an aggregated source files rendering server 112 coupled to the computer-readable medium 102, and a display device 114 coupled to the computer-readable medium 102.

In the example system shown in FIG. 1, the geometric playback surface mapping server 104, the subdivided source files server 106, the synchronized source file player control server 108, the virtualized sensor tracking server 110, the aggregated source files rendering server 112, and the playback device 114 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the geometric playback surface mapping server 104, the subdivided source files server 106, the synchronized source file player control server 108, the virtual sensor tracking server 110, the aggregated source files rendering server 112, the playback device 114, or other applicable devices, systems, or servers described in this paper can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

A computer system can also be implemented as using a datastore or multiple datastores. As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The term “Internet” as used in this paper refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. Applicable known or convenient physical connections of the Internet and the protocols and communication procedures of the Internet and the web are and/or can be used.

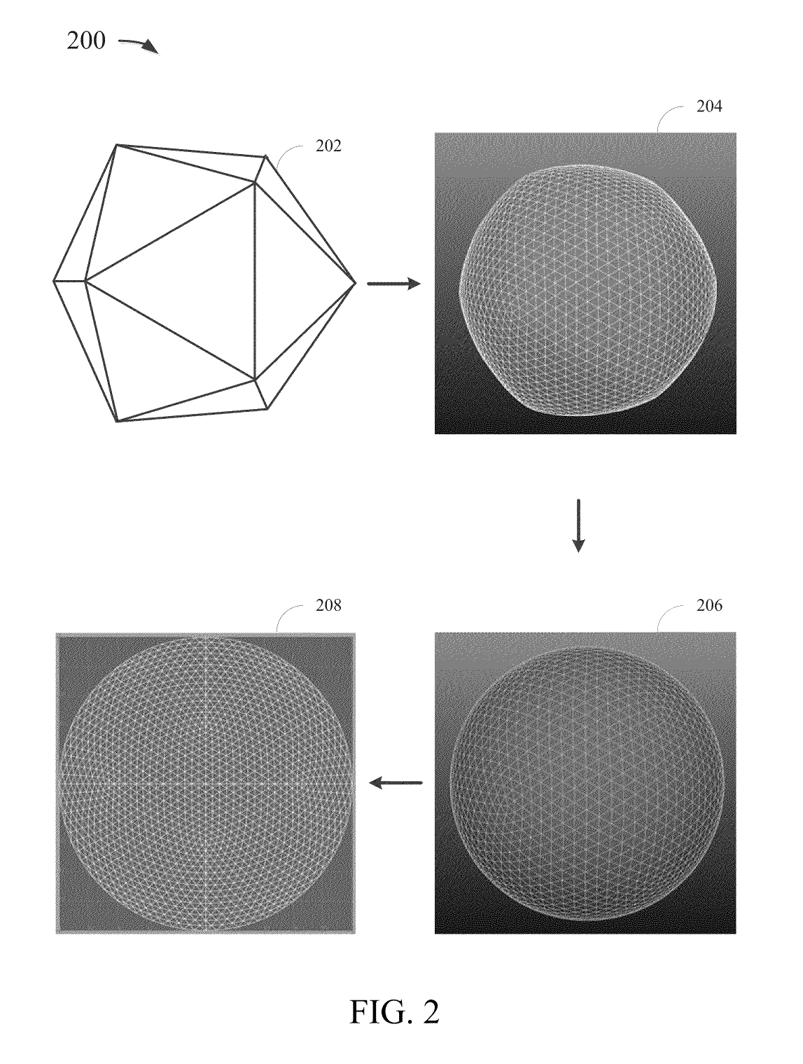

In a specific implementation, the geometric playback surface mapping server 104 functions to receive and provide a geometric playback surface onto which textures can be mapped. Depending upon implementation-specific or other considerations, the geometric playback surface received and provided by the geometric playback surface mapping server can be predefined for a given system, predetermined for a given system, or selectable on a given system. For example, a commercial camera could be provided with a geometric playback surface appropriate for the capabilities of the camera when the camera is manufactured (perhaps with the capability of receiving firmware or other updates in a known or convenient manner). As another example, a geometric playback surface could be selected in accordance with a lens selection or for a camera (e.g., a wide-angled lens could be associated with a particular geometric playback surface). As another example, a playback device user, network server admin, device manufacturer, or other entity could develop or select a number of different geometric playback surfaces on demand for given parameters. An example of creating a three-dimensional geometric playback surface is described in greater detail later with reference to FIG. 2.

In a specific implementation, the geometric playback surface mapping server 104 can define coordinates to map texture imagery onto the geometric playback surface. In an example, the geometric playback surface mapping server 104 can use UV texture mapping in 3D graphical processing unit (hereinafter referred to as “GPU”) rendering. For example, a geometric playback surface map can be generated as a set of UV coordinates generated using the following algorithm:

for vertex in sphere.verts:
position=vertex.getPosition(space=“world”)
u=math.sqrt(2/(1-position.z))*position.x*⅓+0.5
v=math.sqrt(2/(1-position.z))*position.y*⅓+0.5
faces=vertex.connectedFaces( ).indices( )
vertex.setUVs([u] *len(faces), [v]*len(faces), faces)

This result is then re-normalized between 0-1 to serve as a base UV. To fit the normalized version to a final map, UVs are first corrected for video aspect ratio, and then uniformly scaled to match a diameter and position of, e.g., a hemispherical playback image. Depending upon implementation-specific or other considerations, if multiple players are used, UV coordinates can be split in the same manner as the geometry (see, e.g., FIG. 2), and translated so an orthogonal corner fits perfectly along two adjoining edges.

In a specific implementation, the subdivided source files server 106 functions to receive playback content and provide source files that include playback content. The subdivided source files server 106 can receive playback content as input. Playback content input into and provided for by the subdivided source files server 105 can be created in a number of ways including using a camera (to take still photos or video), an audio recorder, or an editor to create computer-generated clips, create movies from various files, or the like. Less typical playback content is also possible, such as by measuring wind speed (perhaps for playback using a fan), measuring temperature (perhaps for playback using a heater or cooler), measuring humidity, or using some other known or convenient sensor to detect a stimulus of interest in playback or for informational purposes during playback (perhaps as an augmented reality with gauges or the like).

In a specific implementation, the subdivided source files server 106 functions to provide playback content as subdivided source files that are appropriate for subdivisions of a geometric playback surface. Depending upon implementation specific or other considerations, the subdivided source files server 106 can function to subdivided a source file that contains a single high resolution video into a plurality of subdivided source files that include portions of the single high resolution video. In subdividing a source file into a plurality of subdivided source files, the subdivided source files server 106 can divide portions of a source file and store each divided portion of the source file into subdivided source files. The subdivided source files can be compressed for easy transfer. In subdividing a source file that is a video, the subdivided source files server 106 can divide each frame of the video into portions based on an array of pixels that form at least part of the frame. For example, the subdivided source files server 106 can use data about pixels within an array formed by columns 1-500 and rows 1-500 of the pixels that form a frame to generate a first subdivided source file and data about pixels within an array formed by columns 1-500 and rows 501-1000 of the pixels that form the frame to generate a second subdivided source file.

In a specific implementation, the subdivided source files server 106 provides playback content as subdivided source files that are appropriate for subdivisions of a geometric playback surface input into and/or provided for by the geometric playback surface mapping server 104. Playback content may or may not be received by the subdivided source files server 106 in a format that enables playback within subdivisions of a geometric playback surface. More specifically, when playback content cannot be displayed in subdivisions, in particular subdivisions of a geometric playback surface, or at least not in a desired manner within the subdivisions, the subdivided source files server 106 can be configured to split the playback content into source files that can be displayed as required or desired based on the subdivisions.

In a specific implementation, the synchronized source file player control server 108 functions to control multiple source file players. Source file players controlled by the source file player control server 108 can be integrated on or to operate with the playback device 114 to play source files that include playback content and thereby cause playback content to be displayed or played on the playback device 114. Depending upon implementation-specific or other considerations, each of the source file players plays controlled by the synchronized source file control server 108 can play one of the subdivided source files provided by the subdivided source files server 106. Thus, each source file player can be associated with one of the subdivisions of a geometric playback surface. If source file players were not synchronized problems could include, for example, buffering a portion of the playback content that does not correspond in time to another portion of the playback content. Therefore, source file players can be synchronized through control by the synchronized source file player control server 108 to enable the source file players, in the aggregate, to buffer playback content appropriate for a given time. Further, in source file players buffering playback content, each of the buffers can store a texture that is suitable for mapping to a three-dimensional geometric playback surface, such as geometric playback surfaces provided for by the geometric playback surface mapping server 104. Depending upon implementation-specific or other considerations, for playback content that is not image-based, buffers used by source file players in buffering playback content, can store a value that is more appropriate for the content.

In a specific implementation, the aggregated source files rendering server 112 functions to map aggregated playback content to a geometric playback surface. Aggregated playback content can include playback content included in one or a plurality of source files, including subdivided source files, provided by the subdivided source files server 106 and played by source file players controlled by the synchronized source file player control server 108. Depending upon implementation-specific or other considerations, the aggregated source files rendering server 112 can map aggregated playback content to a geometric playback surface received from the geometric playback surface mapping server 104. Further depending upon implementation-specific or other considerations, each of the buffers of the synchronized source file player control server 108 can store a texture that the aggregated source files rendering server 112 applies to a geometric playback surface provided for by the geometric playback surface mapping server 104.

In a specific implementation, the virtual sensor tracking server 110 receives playback sensor feedback as input and provides a virtual sensor. A virtual sensor provided for by the virtual sensor tracking server 110, can be used to indicate what aggregated playback content that has been mapped to a geometric playback surface to play or display. Depending upon implementation-specific or other considerations, a virtual sensor provided for by the virtual sensor tracking server 110, indicates a portion of an aggregated playback that is mapped to a geometric surface provided for by the geometric playback surface mapping server 104, to play or display. In one example, the virtual sensor tracking server 110 provides a virtual sensor based on received playback sensor feedback. Further, the virtual sensor tracking server 110 can provide a virtual sensor at an initial virtual sensor location based upon sensor feedback. For example, a virtual sensor could initially be centered on a geometric playback surface. Depending upon implementation-specific or other considerations, the virtual sensor tracking server 110 provides a virtual sensor within a geometric playback surface provided for by the geometric playback surface mapping server 104.

In a specific implementation, the virtual sensor tracking server 110 moves a placed virtual sensor based on received playback sensor feedback. Further in the specific implementation, the virtual sensor tracking server 110 can move a placed virtual sensor within a geometric playback surface provided for by the geometric playback surface mapping server 104 based on received playback sensor feedback, as will be discussed in greater detail later. As a result, as a virtual sensor is moved within a geometric playback surface, a portion of played aggregated playback content that is mapped to the geometric playback surface can change.

In a specific implementation, the playback device 114 plays or displays aggregated playback content mapped to a geometric playback surface. For example, the playback device 114 plays aggregated playback content that is mapped to a geometric playback surface by the aggregated source files rendering server 112. Further in the implementation, the playback device 114 can play or display aggregated playback content using source file players controlled by the synchronized source file player control server 108. Depending upon implementation-specific or other considerations, the playback device 114 plays only a portion of the aggregated playback content mapped to a geometric playback surface based on a virtual sensor. Over time, the contents of the playback content can change. Further depending upon implementation-specific or other considerations, as playback sensor feedback is received, a virtual sensor can be moved causing the playback device 114 to play and thereby revealing different portions of aggregated playback content. Advantageously, moving a virtual sensor to reveal portions of the aggregated playback content can lead to an immersive playback experience, enable a higher resolution image to be displayed (in parts) than is normally possible for the playback device 114, and offer other technical and aesthetic benefits.

In an example of operation of the example system shown in FIG. 1, the geometric playback surface mapping server can function to provide a geometric playback surface upon which playback content can be mapped to and displayed or played. Further in the example of operation, the subdivided source files sever 106 can function to provide playback content as source files that are appropriate for subdivisions of a geometric playback surface provided by the geometric playback surface mapping server 104. In the example of operation of the example system shown in FIG. 1, the synchronized source file player control server 108 can function to control source file players that play playback content according to subdivisions of a geometric playback surface through a playback device 114. Still further in the example of operation of the example system shown in FIG. 1, the virtual sensor tracking server 110 can function to provide a virtual sensor for a geometric playback surface provided by the geometric playback surface mapping server 104. Additionally, in the example of operation, the aggregated source files rendering server 112 can function to map aggregated playback content to a geometric playback surface provided by the geometric playback surface mapping server 104. In the example of operation, the playback device 114 plays or displays aggregated playback content that is mapped to the geometric playback surface mapping server 104 according to the playback content to play or display indicated by a virtual sensor for the geometric playback surface provided for by the virtual sensor tracking server 110.

FIG. 2 is intended to illustrate a specific example of generating geometric playback surface portions from a base geometry. Depending upon implementation-specific or other considerations, an applicable system or server, such as the geometric playback surface mapping servers described in this paper, can be used to generate a geometric playback surface of portions of a geometric playback surface according to the example shown in FIG. 2. Further depending upon-implementation specific or other considerations, an applicable system or server, such as the aggregated source files servers described in this paper, can be used to map aggregated playback content to a geometric playback surface or portions of a geometric playback surface created according to the example shown in FIG. 2.

In a specific implementation, a base geometry 202 that is an icosahedron (a 12-sided platonic solid of equilateral triangles) is generated. Simpler base geometries include, for example, 2-D base geometries, such as a plane can be generated. Three dimensional base geometries are more complex; so a 3-D base geometry is illustrated by way of example.

In a specific implementation, a base geometry 202 linear subdivision (a midpoint of each edge is connected to the other edges in each triangle, creating four triangles for each original triangle) is used to create an intermediary geometry 204. In the example of FIG. 2, recursive linear subdivision has been used, with four recursions to obtain the illustrated subdivided icosahedron. In alternative implementations, an applicable known or convenient subdivision technique can be used in lieu of linear subdivision.

In a specific implementation, the intermediary geometry 204 is modified by pushing each vertex along the vector radiating from the center of the sphere out to a radius of one to create a single mapping geometry 206. Depending upon implementation-specific or other considerations, the single mapping geometry is a target shape of the geometric playback surface. In the example of FIG. 2, the single mapping geometry 206 is a sphere. In alternative implementations, an applicable shape, such as a column or a plane, can be the target single mapping geometry in lieu of a sphere.

In a specific implementation, the single mapping geometry 206 is split into playback surface portions to create a subdivision mapping geometry 208. In the example of FIG. 2, the subdivision mapping geometry 208 includes four subdivisions, not all of which need be used to map an image (e.g., an image could be mapped to a hemisphere, which would correspond to two of the four subdivisions of the subdivision mapping geometry 208). In alternative implementations, a desired number of subdivisions can be used instead of four (or two, if the mapping surface of FIG. 2 is hemispherical).

It may be noted that some other base geometry could be used, which can result in a different intermediary geometry. The amount of recursion (if recursion is used at all) can result in a smaller or larger number of vertices. The shape of the single mapping geometry can vary depending upon the base geometry and/or the subdivision technique employed to increase the number of vertices. Example single mapping geometries are spherical, columnar, and planar, the former two being two of a very large number (theoretically infinite) of 3-D single mapping geometries, the latter being presumably rectangular though there is no theoretical reason the planar single mapping geometry could not have some other shape (e.g., circular). The number of subdivisions of the subdivision mapping geometry can depend upon implementation-specific, configuration-specific, and/or device-specific factors.

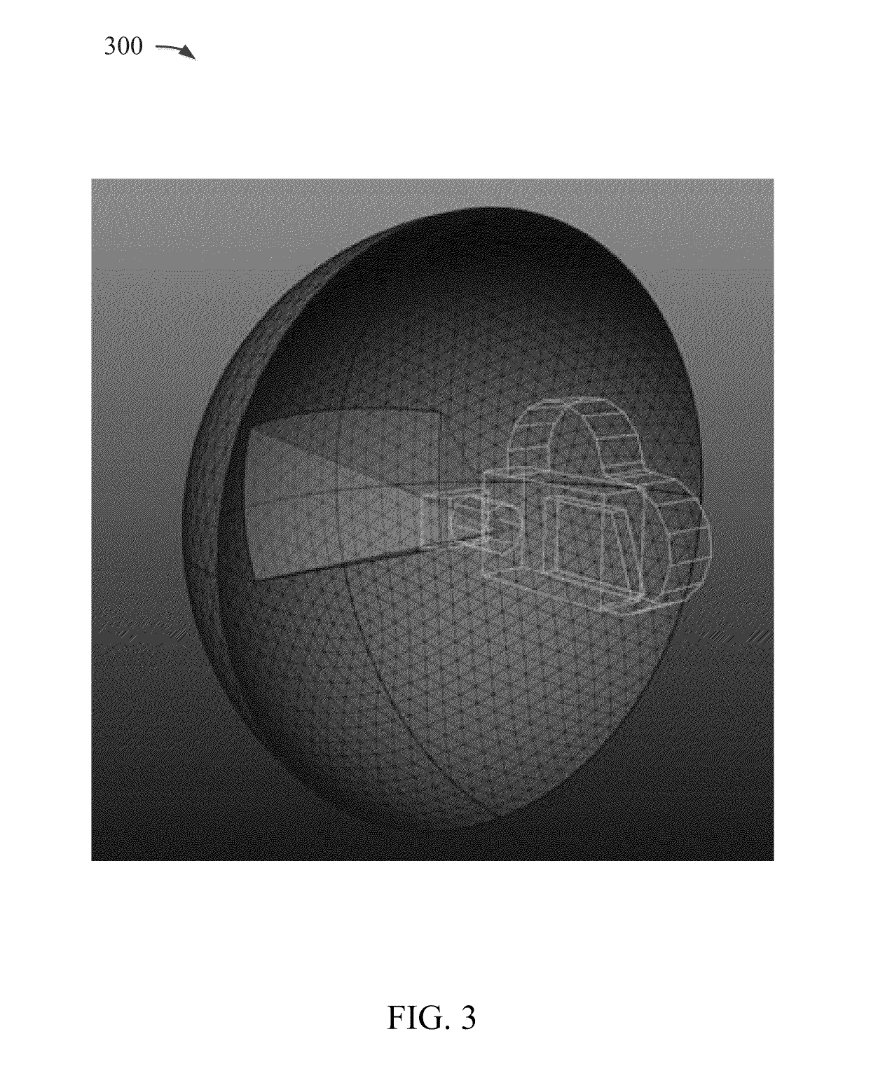

FIG. 3 is intended to illustrate a specific example of a virtual sensor centered on a geometric playback surface. For illustrative purposes only, the virtual sensor is illustrated as a line drawing of a camera in accordance with an implementation that utilizes a video image. For illustrative purposes only, the geometric playback surface is illustrated as a hemispherical 3-D surface. Depending upon implementation-specific or other considerations, an applicable system or server, such as the geometric playback mapping servers described in this paper, can provide a geometric playback surface upon which a virtual sensor is placed according to the example shown in FIG. 3. Further depending upon implementation-specific or other considerations, an applicable system or server, such as the virtual sensor tracking servers described in this paper can place a virtual sensor on a geometric playback surface according to the example shown in FIG. 3.

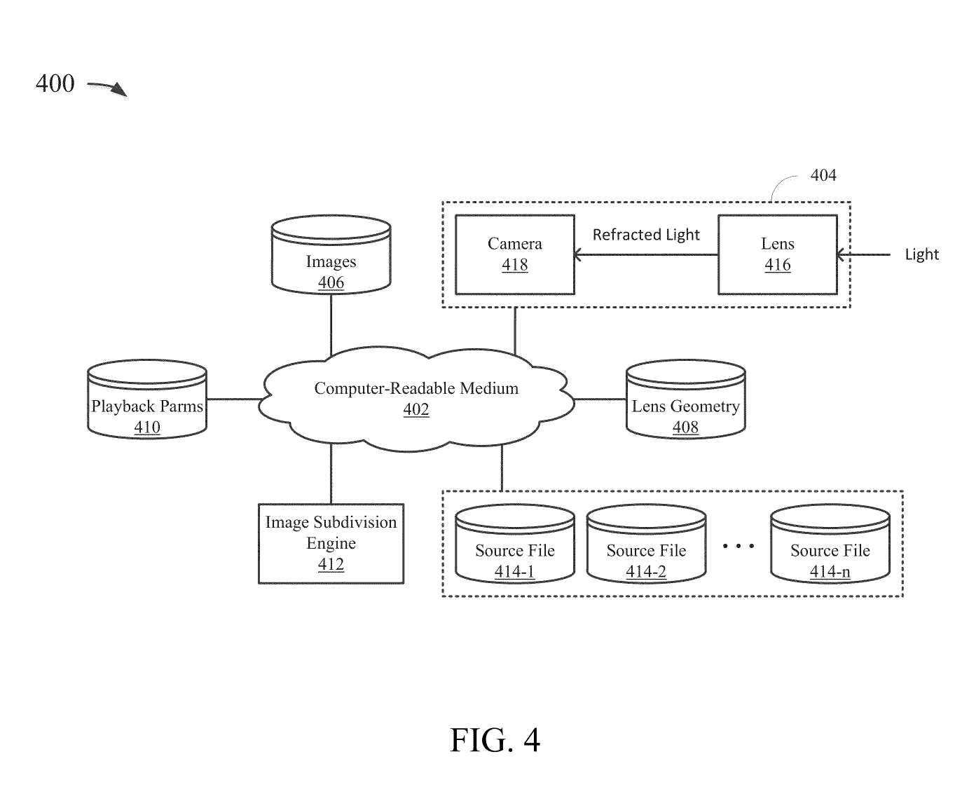

FIG. 4 depicts a diagram 400 an example of a system for recording video content as playback content and storing the video content in subdivisions for synchronized aggregated playback. Depending upon implementation-specific or other considerations, the example system or portions of the example systems shown in FIG. 4 are integrated as part of or to operate with applicable systems or servers for providing subdivided source files, such as the subdivided source file servers described in this paper. The example system shown in FIG. 4 includes a computer-readable medium 402, a video recording device 404 coupled to the computer-readable medium 402, an images datastore 406 coupled to the computer-readable medium 402, a lens geometry datastore 408 coupled to the computer-readable medium 402, a playback parameters datastore 410 coupled to the computer-readable medium 402, an image subdivision engine coupled to the computer-readable medium 402, and source file datastores 414-1 to 414-n (collectively referred to as the source file datastores 414).

In a specific implementation, the computer-readable medium 402 can be implemented as described by way of example with reference to FIG. 1.

In a specific implementation, the video recording device 404 includes a lens 416 and a camera 418. The video recording device 404 can also include other sensors (not shown), and consumer products often include at least an audio sensor. Moreover, the video recording device 404 can be modified to detect electromagnetic radiation outside of the more common recording devices that detect visible light. In some cases, the term “camera” can refer to a device capable of detecting both sound and visible light (e.g., a camcorder). It is possible to use a variety of sensors to measure temperature, vibration, wind speed, or the like, but applicable components associated with recording stimuli other than electromagnetic radiation are omitted in the example of FIG. 4. Additional sensors can be used to improve the immersive feel of a playback experience or provide data of informative interest.

In a specific implementation, the lens 416 is intended to represent a simple or compound optical device that refracts light. A simple lens includes of a single optical element. A compound lens is an array of optical elements with a common axis; the use of multiple optical elements is generally considered to be more effective at correcting optical aberrations than is possible with a single element. Lenses are typically made of glass or transparent plastic. Elements which refract electromagnetic radiation outside the visual spectrum are also called lenses: for instance, a microwave lens can be made from paraffin wax.

In a specific implementation, the camera 418 is a device that records still or moving images (e.g., pictures or videos). A camera generally includes an enclosed hollow with an aperture for light to enter, and a recording surface for capturing electromagnetic radiation that enters. The diameter of the aperture is often controlled by a diaphragm mechanism, but some cameras have a fixed-size aperture. Most cameras use an electronic image sensor to store photographs on flash memory. Other cameras, particularly the majority of cameras from the 20th century, use photographic film. It is not uncommon to refer to the lens 416 and the camera 418, collectively, as a camera. Some cameras do not include a lens to refract light prior to the light entering the aperture of the camera.

In a specific implementation, the images datastore 406 functions to store images captured by the camera 418. The format of data structures of the images datastore 406 is implementation-specific, but the elements typically conform to either a standard or proprietary format. The images datastore 406 can be implemented locally (such as a camera) and/or remotely (such as an off-camera computing device).

In a specific example, the lens geometry datastore 408 functions to store data associated with the lens 416. Data stored in the lens geometry datastore 408 can be obtained from an agent of the camera 418 that can detect the type of lens 416, in response to one or any combination of the following: a registration process for a newly purchased (or at least newly registered) recording device, user input, analysis of images in the images datastore 406, or using some other technique suitable for determining or predicting characteristics of the lens 416 for the purpose of selecting a geometric playback surface appropriate, suitable, or possible for images captured using the lens 416.

In a specific implementation, the lens geometry datastore 408 can function to store one or more geometric playback surfaces. Depending upon implementation-specific or other considerations, the lens geometry data 408 can be implemented as part of a system or server that provides a geometric playback surface, such as the geometric playback mapping servers described in this paper. Geometric playback surfaces stored in the lens geometry datastore 408, can be associated with the type of lens that was originally used to capture a subset of the images in the images datastore 406. In one example, a geometric playback surface stored in the lens geometry datastore 408 can be generated in advance of the video recording device 404 storing or providing any images, such as for a particular standard; a particular model of camera before the camera is manufactured, sold, or used; a category of devices having certain capabilities, etc. Alternatively or in addition, the geometric playback surface can be generated on demand, for example as the camera 418 captures images.

In a specific implementation, the playback parameters datastore 410 includes data associated with a playback device. A number of subdivisions of a geometric playback surface can be associated with the capabilities or settings of a playback device, included as data associated with the playback device stored in the playback parameters datastore 410. Accordingly, data associated with a playback device stored in the playback parameters datastore 410 can be useful if the number of subdivisions in a specific implementation should be adjusted based upon playback device characteristics. Specifically, the number of subdivisions of source files that are mapped to a geometric playback surface as aggregated playback content that is played or displayed by a playback device can be changed based on data associated with the playback device stored in the playback parameters datastore 410.

The example system shown in FIG. 4 includes an image subdivision engine 412. In a specific implementation, the image subdivision engine 412 splits images in the images datastore 406 into n source files, where ‘n’ is the number of subdivisions, for storage in the source file datastores 414. In a specific implementation, a recording device can be configured to store images in subdivided source files. Depending upon implementation-specific or other considerations, the image subdivision engine 412 can split images in the image datastore into n source files, based on data associated with a playback device stored in the playback parameters datastore 410.

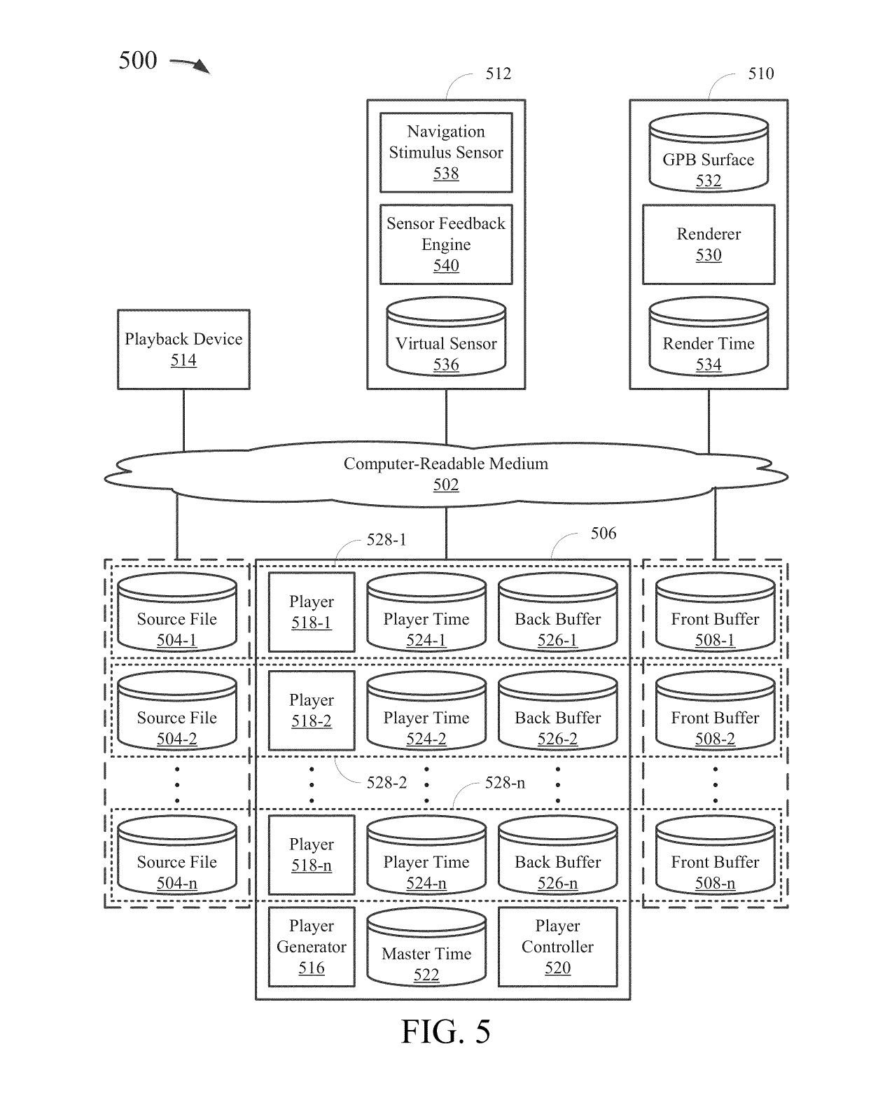

FIG. 5 depicts a diagram 500 of an example of a system for displaying a portion of playback content revealed by a virtual sensor. Depending upon implementation-specific or other considerations, portions of the example system shown in FIG. 5 can be implemented as part of or in communication with a system or server for providing a virtual sensor, such as the virtual sensor tracking servers described in this paper. Further depending upon implementation-specific or other considerations, portions of the example system shown in FIG. 5, can be implemented as part of or in communication with systems or servers for controlling source file players that are used to play source files that include playback content, such as the synchronized source file player control servers described in this paper. Additionally depending upon implementation-specific or other considerations, portions of the example system shown in FIG. 5 can be implemented as part of or in communication with systems or servers configured to provide source files that include playback content, such as the synchronized source file servers described in this paper. Also depending upon implementation-specific or other considerations, portions of the example system shown in FIG. 5 can be implemented as part of or in communication with systems or servers configured to provide geometric playback surfaces, such as the geometric playback mapping servers described in this paper.

The example system shown in FIG. 5 includes a computer-readable medium 502, source file datastores 504-1 to 504-n (collectively referred to as source file datastores 504) coupled to the computer-readable medium 502. The example system shown in FIG. 5 also includes a synchronized source file player controller engine 506 coupled to the computer-readable medium 502, front buffer datastores 508-1 to 508-n (collectively referred to as front buffer datastores 508) coupled to the computer-readable medium 502, a geometric playback surface rendering engine 510 coupled to the computer-readable medium 502, a virtual sensor tracking engine 512 coupled to the computer-readable medium 502, and a playback device 514 coupled to the computer-readable medium 502.

In a specific implementation, the computer-readable medium 502 can be implemented as described by way of example with reference to FIG. 1.

In a specific implementation, the source file datastores 504 function to store playback content subdivided for playback on a geometric playback surface. The source file datastores 504 can function to store playback content that is either or both created in advance or on demand, depending upon implementation-, configuration-, and device-specific factors. Additionally, the source file datastores 504 can either or both be created in advance or on demand, depending upon implementation-, configuration-, and device-specific factors. When source file datastores 504 are created on demand, an image subdivision engine can access a playback content datastore with playback content that can be subdivided into source files for subdivisions of a geometric playback surface.

In the example system shown in FIG. 5, the synchronized source file player controller engine 506 includes a player generator 516, players 518-1 to 518-n (collectively referred to as the players 518), a player controller 520, a master time datastore 522, player time datastores 524-1 to 524-n (collectively referred to as the player time datastores 524), and back buffer datastores 526-1 to 526-n (collectively referred to as the back buffer datastores 526).

In a specific implementation, the player generator 516 functions to create a player for each source file, both of which correspond to a subdivision of a subdivided playback surface geometry. Conceptually, a source file 504-i, player 518-i, subdivision i (not shown) and other corresponding timers and buffers for the player 518-i can be grouped, as is illustrated by dotted boxes of subdivision subsystems 528-1 to 528-n (referred to collectively as the subdivision subsystems 528) in the example of FIG. 5.

In a specific implementation, the player controller 520 uses a master time maintained in the master time datastore 522 to control each of the players 518-i in accordance with the player time stored in the corresponding player time datastore 524-i. Depending upon implementation-specific or other considerations, when player time for a player 518-i is less than master time 522, the player 518-i is given an opportunity to read an image from the source file datastore 504-i into the back buffer datastore 526-i. In an example, when all of the players 518 have read the relevant image into the back buffer datastores 526, the player controller 520 outputs the playback content stored in each of the back buffer datastores 526 into the corresponding front buffer datastores 508. Further depending upon implementation-specific or other considerations, the front buffer datastores 508 store textures for use in mapping onto 3-D geometry, such as an OpenGL texture.

In the example system shown in FIG. 5, the geometric playback surface rendering engine 510 includes a renderer 530, geometric playback surface datastore 532, and a render time datastore 534. Depending upon implementation-specific or other considerations, the geometric playback surface rendering engine 510 can be integrated as part of or in communication with an applicable system or server for mapping aggregated playback content to a geometric playback surface, such as the aggregated source file rendering servers described in this paper. For the purposes of this example, the geometric playback surface datastore 532 stores a geometric playback surface. In a specific implementation, the renderer 530 maps the contents of the front buffers 508 into subdivisions of the geometric playback surface. The render rate of the renderer 530 can be in accordance with a render time of the render time datastore 534. In a specific implementation, the render time is 60 frames per second because that tends to result in a playback experience that is relatively pleasing to humans. The renderer 530 runs independently of the players 518; so the renderer 530 can update playback content on the geometric playback surface at a high rate (e.g., 60 fps), even when new samples are provided by the players 518 at a slower rate (e.g., 24 or 30 fps).

In the example system shown in FIG. 5, the virtual sensor tracking engine 512 includes a virtual sensor datastore 536, a navigation stimulus sensor 538, and a sensor feedback engine 540. Depending upon implementation-specific or other considerations, the virtual sensor tracking engine 512 can be implemented as part of or in communication with an applicable system or server for placing and controlling a virtual sensor in a geometric playback surface, such as the virtual sensor tracking servers described in this paper. In a specific implementation, the virtual sensor datastore 536 includes a current location of a virtual sensor within a geometric playback surface. The virtual sensor datastore 536 can also include a starting location for a virtual sensor (e.g., a centered location).

In a specific implementation, the navigation stimulus sensor 538 can detect stimuli associated with navigation within a playback experience. Depending upon implementation-specific or other considerations, navigation stimuli can include explicit instructions through a touch screen or other input device. Further depending upon implementation-specific or other considerations, navigation stimuli can also include movement of a device, such as revolving a playback device around a central point, as detected by movement detecting sensors. Movement detecting sensors can include, for example, accelerometers. The sensor feedback engine 540 can interpret signals from the navigation stimulus sensor 538 and to, when appropriate, move the virtual sensor to a new location within a geometric playback surface.

In a specific implementation, the playback device 514 functions according to an applicable device capable of playing or displaying playback content, such as the playback devices described in this paper. Depending upon implementation-specific or other considerations, the playback device 514 displays only a portion of the playback content. For example, the playback device 514 can display a portion that is revealed by a virtual sensor. Depending upon implementation-specific or other considerations, a virtual sensor can reveal a portion of a resolution up to and including the resolution of a display device on the playback device 514 (or window defining a subset of the display device).

In a specific implementation, the playback device 514 displays a single video stream at high resolution yet may still have a limitation on the size of texture that can be used by the GPU for 3D texture mapping. Further in the specific implementation, as each sample is read from the player, individual portions are prepared as separate textures to be mapped onto the subdivisions of the geometric playback surface.

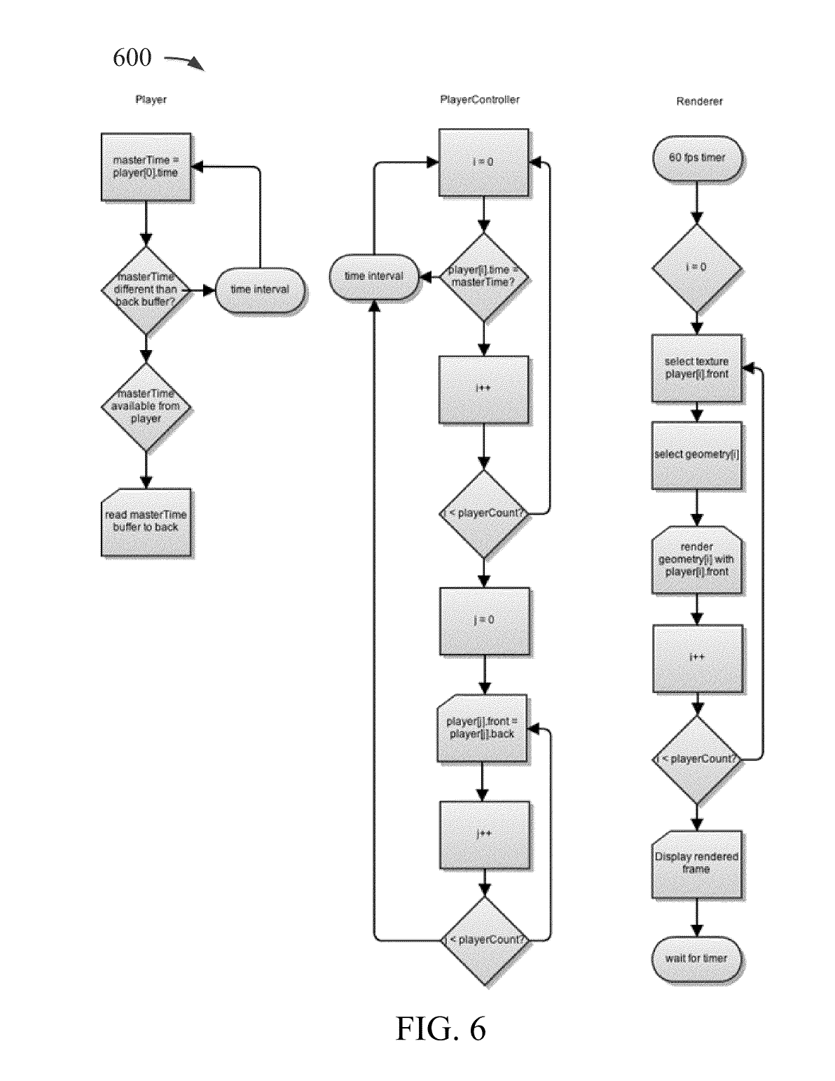

FIG. 6 depicts a flowchart 600 of an example of a method of controlling playback flow between source file players and a renderer. This flowchart and other flowcharts described in this paper are presented in the form of serially arranged modules. However, if applicable, the modules can be reordered or rearranged for parallel execution.

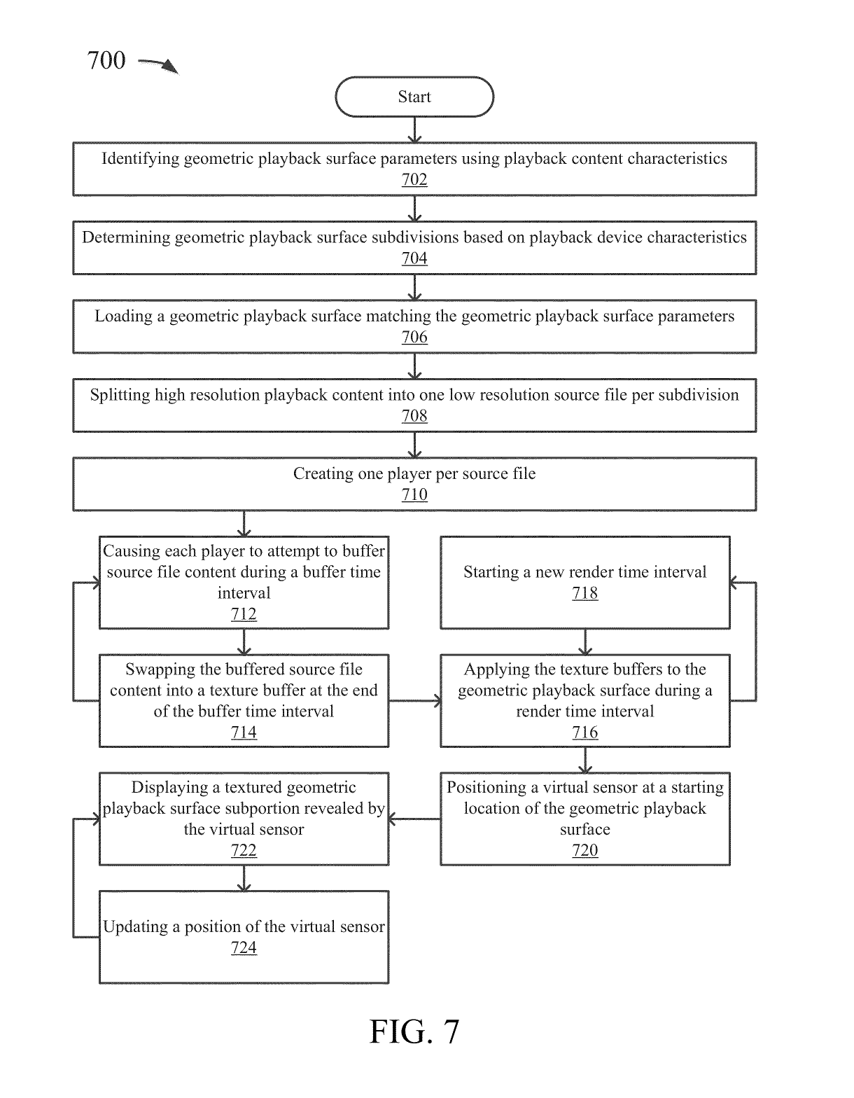

FIG. 7 depicts a flowchart 700 of an example of a method of dividing high resolution video frames into multiple low resolution video frames to support immersive playback resolution on a playback device. In the example of FIG. 7, the flowchart 700 starts at module 702 with identifying geometric playback surface parameters using playback content characteristics. Depending upon implementation-specific or other considerations, applicable systems or servers for generating and/or providing geometric playback surfaces, such as the geometric playback mapping servers described in this paper, can be configured to identify geometric playback surface parameters using playback content characteristics. The playback content characteristics can be identifiable from the playback content or can be identified explicitly by providing information about an aspect of the playback content. For example, if the playback content was shot using a wide-angled lens or a 3-D camera, that information could be provided explicitly.

In the example of FIG. 7, the flowchart 700 continues to module 704 with determining geometric playback surface subdivisions based on playback device characteristics. The playback device characteristics can include display capabilities, such as maximum playback resolution. For example, if the maximum playback resolution of a device is ¼ the resolution of the playback content, four subdivisions might be determined to be appropriate.

In the example of FIG. 7, the flowchart 700 continues to module 706 with loading and/or generating and loading a geometric playback surface matching the geometric playback surface parameters. Depending upon implementation-specific or other considerations, applicable systems and servers, such as the geometric playback mapping servers described in this paper, can be configured to generate and/or load a geometric playback surface matching the geometric playback surface parameters. The geometric playback surface may or may not be identified explicitly (i.e., by name). Depending upon implementation-specific factors, the matching geometric playback surface might be a best (but imperfect) match.

In the example of FIG. 7, the flowchart 700 continues to module 708 with splitting high resolution playback content into one low resolution source file per subdivision. Because the playback content is larger than the subdivisions, the resolution of the playback content can be characterized as higher.

In the example of FIG. 7, the flowchart 700 continues to module 710 with creating one player per source file. The player can be a source file player that plays or displays playback content included as part of a source file. Depending upon implementation-specific or other considerations, the player can be controlled by an applicable system for controlling players, such as the synchronized source file player control servers described in this paper.

In the example of FIG. 7, the flowchart 700 continues to module 712 with causing each player to attempt to buffer source file content during a buffer time interval. The length of a buffer time interval can be impacted by implementation-, configuration-, and content-specific factors. For example, playback content for display at 24 fps will likely have a longer buffer time interval than playback content for display at 30 fps.

In the example of FIG. 7, the flowchart 700 continues to module 714 with swapping the buffered source file content into a texture buffer at the end of the buffer time interval.

In the example of FIG. 7, the flowchart 700 continues along two paths at once. The flowchart 700 returns along a first path to module 712 and continues as described previously, looping between modules 712 and 714 during each buffer interval. For example, the flowchart 700 could loop between modules 712 and 714 at a rate of 24 cycles per second to buffer content that is being played at 24 fps. The flowchart 700 also continues along a second path.

Specifically, in the example of FIG. 7, the flowchart 700 continues to module 716 with applying the texture buffers to the geometric playback surface during a render time interval. The render time interval can be different than the buffer update time interval (e.g., rendering can be at 60 fps while buffer loading speed can be at 24 fps).

In the example of FIG. 7, the flowchart 700 continues along two paths at once. The flowchart 700 continues along a first path to module 718 with starting a new render time interval and then returns to module 716 and loops between modules 716 and 718 during each render time interval. The flowchart 700 also continues along a second path.

Specifically, in the example of FIG. 7, the flowchart 700 continues to module 720 with positioning a virtual sensor at a starting location of the geometric playback surface. The amount of the geometric playback surface that the virtual sensor reveals can be dependent upon the display capabilities of a playback device. For example, if a device can display at 1080p, the virtual sensor can reveal as much of a playback content frame as will fit in 1080p. It may also be desirable to set the virtual sensor at less than the display capabilities of the display device if it is desirable to pan around an image even when the display device can show the image all at one time.

In the example of FIG. 7, the flowchart 700 continues to module 722 with displaying a textured geometric playback surface sub-portion revealed by a virtual sensor. Depending upon implementation-specific or other considerations, a virtual sensor can be provided for and controlled by an applicable system or server for provided and controlling the movement of a virtual sensor, such as the virtual sensor tracking servers described in this paper.

In the example of FIG. 7, the flowchart 700 continues to module 724 with updating a position of the virtual sensor. The position of the virtual sensor can change when a navigation device is used. In a specific implementation, virtual sensor positioning controls include moving a playback device playing around (e.g., revolving the playback device around a center point).

In the example of FIG. 7, the flowchart 700 returns to module 722 as described previously and loops between modules 722 and 724. It may be noted that although the example of FIG. 7 does not include an end, the flowchart can end in the usual manner (e.g., if the playback device is turned off, if the playback content runs its course, etc.).

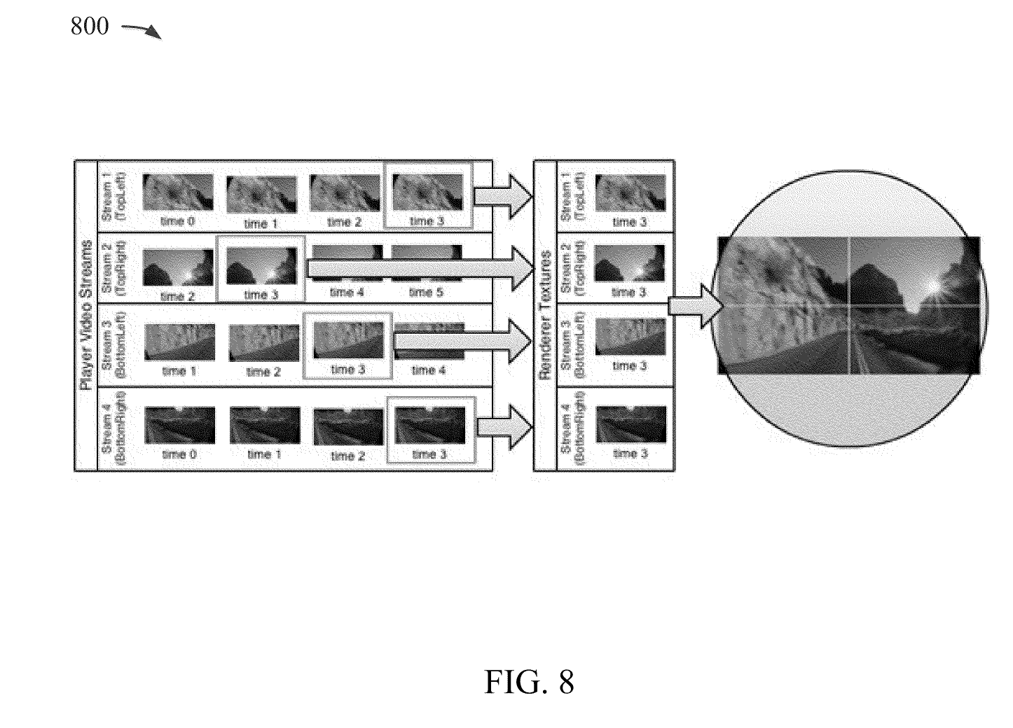

FIG. 8 is intended to illustrate a specific example of playback/rendering flow.

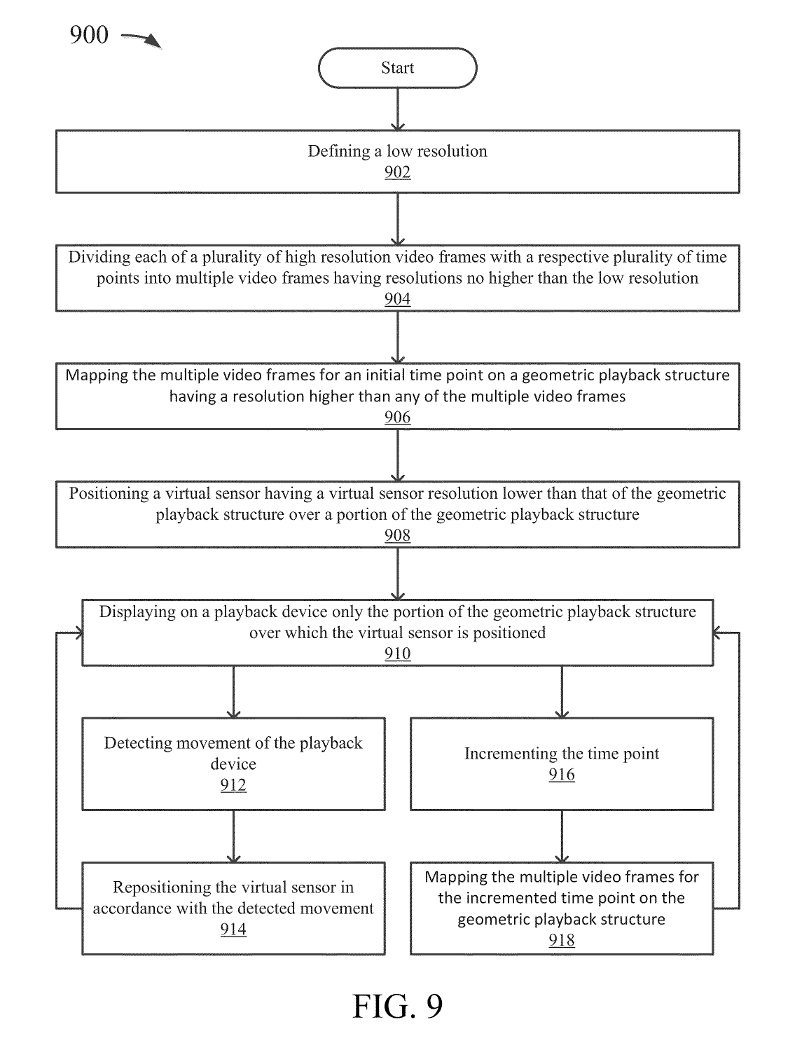

FIG. 9 depicts a flowchart 900 of an example of a method of dividing high resolution video frames into multiple low resolution video frames to support immersive playback resolution on a playback device. In the example of FIG. 9, the flowchart 900 starts at module 902 with defining a low resolution. The low resolution may or may not be the same as a display resolution of a target playback device.

In the example of FIG. 9, the flowchart 900 continues to module 904 with dividing each of a plurality of high resolution video frames with a respective plurality of time points into multiple video frames having resolutions no higher than the low resolution. The time points for a high resolution video frame correspond to where the high resolution frame exists within a sequence of video frames, where a lower time point is associated with a frame that occurs earlier in the video. When a high resolution video frame is divided into multiple lower resolution video frames, each of the multiple lower resolution video frames has the same time point as the parent high resolution video frame.

In the example of FIG. 9, the flowchart 900 continues to module 906 with mapping the multiple video frames for an initial time point on a geometric playback structure having a resolution higher than any of the multiple video frames. The geometric playback structure may or may not have the same resolution as the parent high resolution video frames. For example, rendering two-dimensional frames in three dimensions could result in a need or desire (e.g., for aesthetic reasons) to change the resolution.

In the example of FIG. 9, the flowchart 900 continues to module 908 with positioning a virtual sensor having a virtual sensor resolution lower than that of the geometric playback structure over a portion of the geometric playback structure. The virtual sensor resolution may or may not be the same as the low resolution and/or a display resolution for a target playback device. Depending upon the capabilities of a specific implementation, it may or may not be possible to change the resolution of the virtual sensor when a playback window changes size. In this way, it becomes possible to maintain resolution when a window is resized, or, in the alternative, decrease/increase resolution when the window is resized.

In the example of FIG. 9, the flowchart 900 continues to module 910 with displaying on a playback device only the portion of the geometric playback structure over which the virtual sensor is positioned. For example, if the virtual sensor has a resolution that matches a full resolution of the playback device, the playback device can display at its full resolution and pan around to see the portions of the frame that are not displayed.

In the example of FIG. 9, the flowchart 900 continues along two paths from the module 910. Along the first path, the flowchart 900 continues to module 912 with detecting movement of the playback device, continues to module 914 with repositioning the virtual sensor in accordance with the detected movement, returns to module 910, and continues along the first path as described previously (in a loop that can last as long as the playback content is played).

In the example of FIG. 9, the flowchart 900 can continue along a second path, where the flowchart 900 continues to module 916 with incrementing the time point, continues to module 918 with mapping the multiple video frames for the incremented time point on the geometric playback structure, returns to module 910, and continues along the second path as described previously (in a loop that can last as long as the playback device content is played).

Advantageously, a user of a playback device can pan around a high resolution image to see a panoramic or wide-angle view of any arbitrary resolution. The only meaningful resolution limitations are those of the display device, which can match the resolution of the virtual sensor, if desired, and computer resources (an unusually high resolution image can tax computational resources or even storage). It is also possible to use a “zoom” function to go beyond the usual resolution display capabilities of a playback device.

These and other examples provided in this paper are intended to illustrate but not necessarily to limit the described implementations. As used herein, the term “implementation” means an implementation that serves to illustrate by way of example but not limitation. The techniques described in the preceding text and figures can be mixed and matched as circumstances demand to produce alternative implementations.

What is claimed is:

1. A method comprising:
generating a geometric playback surface with subdivisions;
subdividing at least one source file that includes playback content into a plurality of subdivided source files;
mapping aggregated playback content from the portion of subdivided source files to the subdivisions of the geometric playback surface;
providing a virtual sensor on the geometric playback surface;
playing a portion of the mapped aggregated playback content on a playback device based on a position of the virtual sensor on the geometric playback surface.

2. The method of claim 1, further comprising:
detecting navigation stimuli associated with navigation within a playback experience of playing the portion of the mapped aggregated playback content on the playback device;
moving the virtual sensor in the geometric playback surface based on the detected navigation stimuli.

3. The method of claim 1, wherein the at least one source file is subdivided into the plurality of subdivided source files based on characteristics of the playback device.

4. The method of claim 1, further comprising:
identifying geometric playback surface parameters based on playback content characteristics of the playback content included in the at least one source file subdivided into the plurality of subdivided source files;
generating the geometric playback surface that matches the geometric playback surface parameters.

5. The method of claim 1, further comprising:
generating a plurality of source file players for each subdivided source file of the plurality of subdivided source files, each source file player of the plurality of source file players uniquely associated with one of the subdivided source files of the plurality of subdivided source files and playing playback content of the one subdivided source file that the each source file player is uniquely associated.

6. The method of claim 1, wherein the at least one source file includes high resolution playback content and each of the subdivided source files include low resolution playback content.

7. The method of claim 1, wherein the virtual sensor has a virtual sensor resolution that is lower than a resolution of the geometric playback surface over the portion of the geometric playback surface.

8. The method of claim 5, further comprising:
causing each source file player to buffer the playback content of the subdivided source file that each source file player is uniquely associated during a buffer time interval;
swapping the playback content of the subdivided source file into a texture buffer during the buffer time interval;
applying the texture buffer to the geometric playback surface during a render time interval.

9. The method of claim 1, wherein generating the geometric playback surface further comprising:
generating a base geometry;
creating an intermediary geometry from the base geometry using linear subdivision;
creating a single mapping geometry from the intermediary geometry, the single mapping geometry being a target shape of the geometric playback surface;
splitting the single mapping geometry into a plurality of playback surface portions to create a geometric playback surface having the plurality of playback surface portions that correspond to the subdivisions of the geometric playback surface.

10. A system comprising:
a geometric playback mapping server configured to generate a geometric playback surface with subdivisions;
an image subdivision engine configured to subdivide at least one source file that includes playback content into a plurality of subdivided source files;
a geometric playback surface rendering engine configured to map aggregated playback content from the portion of subdivided source files to the subdivisions of the geometric playback surface;
a virtual sensor tracking engine configured to provide a virtual sensor on the geometric playback surface;
at least one source file player of a plurality of source file players configured to play a portion of the mapped aggregated playback content on a playback device based on a position of the virtual sensor on the geometric playback surface.

11. The system of claim 10, wherein the virtual sensor tracking engine is further configured to:
detect navigation stimuli associated with navigation within a playback experience of playing the portion of the mapped aggregated playback content on the playback device;
move the virtual sensor in the geometric playback surface based on the detected navigation stimuli.

12. The system of claim 10, wherein the image subdivision engine is further configured to subdivide the at least one source file into the plurality of subdivided source files based on characteristics of the playback device.

13. The system of claim 10, wherein the geometric playback mapping server is further configured to:
identify geometric playback surface parameters based on playback content characteristics of the playback content included in the at least one source file subdivided into the plurality of subdivided source files;
generate the geometric playback surface that matches the geometric playback surface parameters.

14. The system of claim 10, wherein the plurality of source file players are generated for each subdivided source file of the plurality of subdivided source files, each source file player of the plurality of source file players uniquely associated with one of the subdivided source files of the plurality of subdivided source files and playing playback content of the one subdivided source file that the each source file player is uniquely associated.

15. The system of claim 10, wherein the at least one source file includes high resolution playback content and each of the subdivided source files include low resolution playback content.

16. The system of claim 10, wherein the virtual sensor has a virtual sensor resolution that is lower than a resolution of the geometric playback surface over the portion of the geometric playback surface.

17. The system of claim 14, wherein at least one source file player of the plurality of source file players is configured to:
buffer the playback content of the subdivided source file that the at least one source file player is uniquely associated with during a buffer time interval;
swap the playback content of the subdivided source file that the at least one source file player is uniquely associated with into a texture buffer during the buffer time interval;
apply the texture buffer to the geometric playback surface during a render time interval.

18. The system of claim 10, wherein in generating the geometric playback surface, the geometric playback mapping server is further configured to:
generate a base geometry;
create an intermediary geometry from the base geometry using linear subdivision;
create a single mapping geometry from the intermediary geometry, the single mapping geometry being a target shape of the geometric playback surface;
split the single mapping geometry into a plurality of playback surface portions to create a geometric playback surface having the plurality of playback surface portions, the plurality of playback surface portions corresponding to the subdivisions of the geometric playback surface.

19. A system comprising:
means for generating a geometric playback surface with subdivisions;
means for subdividing at least one source file that includes playback content into a plurality of subdivided source files;
means for mapping aggregated playback content from the portion of subdivided source files to the subdivisions of the geometric playback surface;
means for providing a virtual sensor on the geometric playback surface;
means for playing a portion of the mapped aggregated playback content on a playback device based on a position of the virtual sensor on the geometric playback surface.

20. The system of claim 19, further comprising:
means for detecting navigation stimuli associated with navigation within a playback experience of playing the portion of the mapped aggregated playback content on the playback device;
means for moving the virtual sensor in the geometric playback surface based on the detected navigation stimuli.
